(19) United States
(12) Patent Application Publication
(10) Pub. No.: US 2026/0049821 A1
(43) Pub. Date: Feb. 19, 2026

(54) POSITION FIXING SYSTEMS AND METHODS

(71) Applicant: Raymarine UK Limited, Fareham (GB)

(72) Inventors: Andrew George Murray, Leighton Buzzard (GB); Jamie Townsend, Leighton Buzzard (GB)

(21) Appl. No.: 19/277,324

(22) Filed: Jul. 22, 2025

Related U.S. Application Data
(60) Provisional application No. 63/683,681, filed on Aug. 15, 2024.

(51) Int. Cl. G01C 21/20; B63B 49/00

(52) U.S. Cl. CPC G01C 21/203; B63B 49/00; B63B 2201/18; B63B 2203/00

(57) ABSTRACT

An electronic chart system (ECS) is configured to be coupled to a user interface. In one embodiment, the ECS is implemented using a logic device configured to obtain a predicted fix for a watercraft position. Based on the predicted fix, the logic device obtains an electronic chart of an area containing a location of the predicted fix. The logic device searches the electronic chart for static objects whose ranges and/or bearings are viewable from the watercraft at the predicted fix location. Other systems, methods, and devices are also provided.

### CROSS REFERENCE TO RELATED APPLICATIONS

This application claims priority to and the benefit of U.S. Provisional Patent Application No. 63/683,681 filed Aug. 15, 2024 and entitled “POSITION FIXING SYSTEMS AND METHODS,” which is incorporated herein by reference in its entirety.

### TECHNICAL FIELD

One or more embodiments of the invention relate generally to electronic chart systems (ECS's), and more particularly to ECS obtaining watercraft position fixing in watercraft navigation.

### BACKGROUND

Traditionally, watercraft position fixing was performed manually using paper charts and visually observable objects. Modern navigation can be paperless, using electronic charts and the GPS (Global Positioning System) or some other GNSS (Global Navigation Satellite System). A position fix obtained from GNSS can be fed to an Electronic Chart System (ECS), which receives Electronic Navigation Charts (ENC) and displays the watercraft GNSS position on a chart on a suitable display, possibly a multifunction display (MFD).

However, additional position fixing is recommended based on observable objects (e.g. headlands or radio towers) as a “second check”. Such secondary position fixing is particularly valuable should the ship lose the GNSS position fix due to jamming, interference, blocking by land features, or other reasons.

Secondary position fixing usually involves measuring ranges and bearings of static objects located in known locations, and entering the ranges and bearings into ECS which then calculates the secondary fix.

In practice, secondary position fixing is not often undertaken on board vessels, due to the complexity and time required to measure ranges and bearings and enter these values into the ECS. This is so despite the secondary position fixing being mandatory for vessels regulated by the International Convention for the Safety of Life at Sea (SOLAS). This can lead often to “GNSS assisted groundings” where navigators blindly believe the GPS position.

There is a need to improve secondary position fixing to encourage its use by navigators.

### SUMMARY

Systems and methods are disclosed for watercraft position fixing. Such systems and methods can be used for secondary position fixing in some embodiments. In accordance with one or more embodiments, an electronic chart system (ECS) is configured to be coupled to a user interface. The ECS is implemented using a logic device configured to obtain a predicted fix (e.g. GNSS fix) for a watercraft position. Based on the predicted fix, the logic device obtains an electronic chart of an area containing a location of the predicted fix. The logic device searches the electronic chart for static objects viewable from the watercraft at the predicted fix location. (As used herein, the term “viewable” means that the objects may be viewed by the navigator (human being) and/or one or more ranging or other devices on the watercraft.)

The logic device may provide results of the search on the user interface for the navigator to view, and/or may automatically calculate the position fix based on the results.

In accordance with one or more embodiments, a method comprises performing, by a logic device used to implement an electronic chart system (ECS), operations of: obtaining a predicted fix for a watercraft position; based on the predicted fix, obtaining an electronic chart of an area containing a location of the predicted fix; and searching the electronic chart for static objects whose ranges and/or bearings are viewable from the watercraft at the predicted fix location.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1A is a block diagram of a watercraft including a positioning system in accordance with an embodiment of the disclosure.

FIG. 1B is a diagram of a watercraft including a positioning system in accordance with an embodiment of the disclosure.

FIG. 1C is a diagram of a steering sensor/actuator in accordance with an embodiment of the disclosure.

FIG. 2 is a block diagram of an electronic system used to obtain position fixes in accordance with an embodiment of the disclosure.

FIG. 3A illustrates an exemplary map marked up to show a method of obtaining a two-point fix as may be used in an embodiment of the disclosure.

FIG. 3B is a flowchart of obtaining a two-point fix in accordance with FIG. 3A.

FIG. 4A illustrates an exemplary map marked up to show a method of obtaining a two-point fix as may be used in an embodiment of the disclosure.

FIG. 4B is a flowchart of obtaining a two-point fix in accordance with FIG. 4A.

FIGS. 5, 6, and 7 are flowcharts of processes used to obtain position fixes in accordance with embodiments of the disclosure.

FIGS. 8 and 9 are user interface images presented to a navigator in obtaining position fixes in accordance with embodiments of the disclosure.

Embodiments of the invention and their advantages are best understood by referring to the detailed description that follows. It should be appreciated that like reference numerals are used to identify like elements illustrated in one or more of the figures.

### DETAILED DESCRIPTION

In accordance with various embodiments of the present disclosure, position fixing systems and methods may provide assisted, and/or fully automated, position fixing, possibly not relying on GNSS and hence usable as secondary position fixing. In some embodiments, such position fixing systems and methods may automatically identify surface or underwater static objects that can be used to obtain a secondary position fix. (The term “object” is used broadly herein to include point objects such as beacons, line objects such as depth contours, and area objects (areas).) The position fixing systems may perform secondary position fixing automatically or may display a list of suitable static objects and invite the navigator to select static objects for a secondary position fix. The secondary position fix is then automatically calculated based on the navigator selection.

One or more embodiments of the described position fixing systems may advantageously include an electronic chart system (ECS) that is configured to be coupled to a user interface. The ECS may include, or be implemented using, a logic device configured to obtain a predicted fix (e.g. using GNSS and/or dead reckoning and/or a manually obtained fix) for a watercraft position. Based on the predicted fix, the logic device obtains an electronic chart of an area containing a location of the predicted fix. The logic device searches the electronic chart for static objects detectable from the watercraft assuming the watercraft is at the predicted location (i.e. predicted fix location). The logic device controls ranging devices to measure the static object ranges and/or bearings, and calculates the secondary fix based on such ranges and/or bearings.

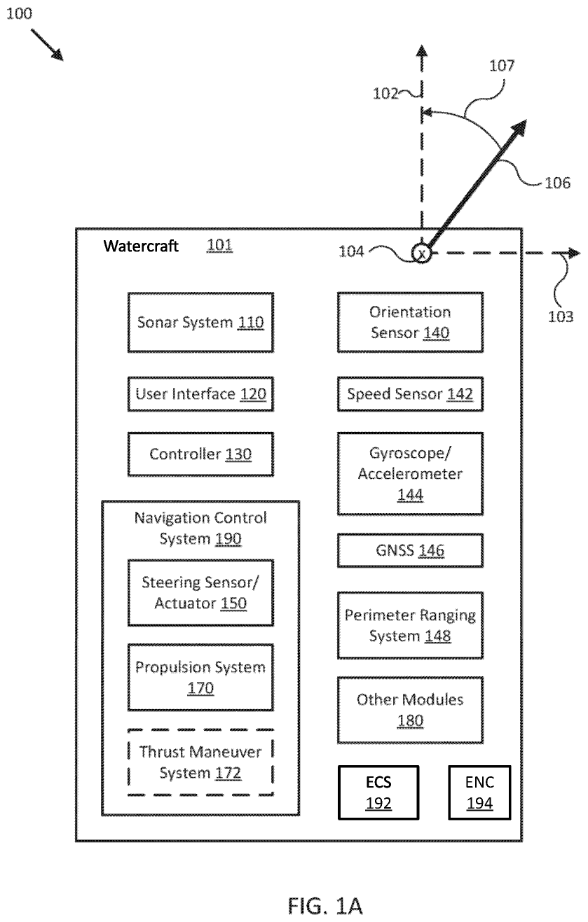

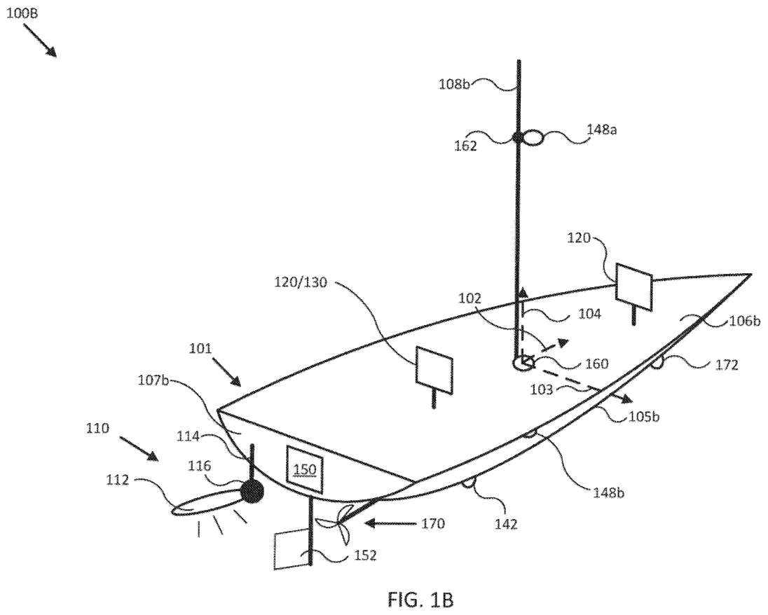

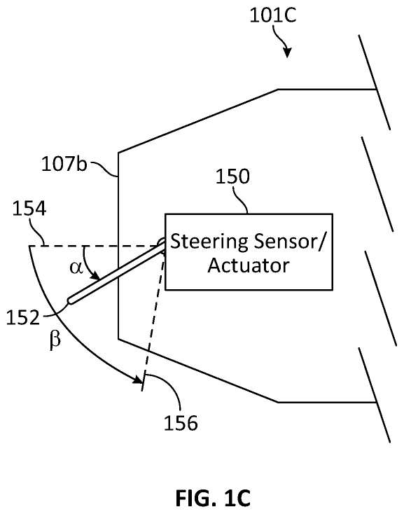

FIG. 1A illustrates a block diagram of a system 100 in accordance with an embodiment of the disclosure. In various embodiments, system 100 may be configured to provide position fixing for a watercraft 101 in an ocean, lake, river, or any other body of water. Position fixing may refer to fully automated position fixing or assisted position fixing where the system provides to the navigator suitable information (e.g. a list of static objects) and obtains a secondary position fix based on static objects selected by the navigator. In some embodiments, system 100 may be configured to measure bearings and/or ranges of static objects, and may then use these measurements to obtain a position fix. The navigator may use primary and/or secondary position fixes to control operation of watercraft 101, possibly by controlling elements of navigation control system 190 (e.g., steering actuator 150, propulsion system 170, and/or optional thrust maneuver system 172) to steer or orient watercraft 101 according to a desired heading or orientation, such as heading angle 107, for example.

In the embodiment shown in FIG. 1A, system 100 may be implemented to provide position fixing for any suitable type of watercraft 101, such as a drone, a robot, an amphibious watercraft, and/or other types of watercraft. In one embodiment, system 100 may include one or more of a sonar system 110, a user interface 120, a controller 130, an orientation sensor 140, a speed sensor 142, a gyroscope/accelerometer 144, a global navigation satellite system (GNSS) 146, a perimeter ranging system 148, a steering sensor/actuator 150, a propulsion system 170, a thrust maneuver system 172, ECS 192, ENC 194, and one or more other parts including sensors and/or actuators used to sense and/or control a state of watercraft 101, such as other modules 180. In some embodiments, one or more of the elements of system 100 may be implemented in a combined housing or structure that can be coupled to watercraft 101 and/or held or carried by a user of watercraft 101.

Directions 102, 103, and 104 describe one possible coordinate frame of watercraft 101 (e.g., for headings or orientations measured by orientation sensor 140 and/or angular velocities and accelerations measured by gyroscope/accelerometer 144). As shown in FIG. 1A, direction 102 illustrates a direction that may be substantially parallel to and/or aligned with a longitudinal axis of watercraft 101, direction 103 illustrates a direction that may be substantially parallel to and/or aligned with a lateral axis of watercraft 101, and direction 104 illustrates a direction that may be substantially parallel to and/or aligned with a vertical axis of watercraft 101, as described herein. For example, a roll component of motion of watercraft 101 may correspond to rotations around direction 102, a pitch component may correspond to rotations around direction 103, and a yaw component may correspond to rotations around direction 104.

Heading angle 107 may correspond to the angle between a projection of a reference direction 106 (e.g., the local component of the Earth's magnetic field) onto a horizontal plane (e.g., referenced to a gravitationally defined “down” vector local to watercraft 101) and a projection of direction 102 onto the same horizontal plane. In some embodiments, the projection of reference direction 106 onto a horizontal plane (e.g., referenced to a gravitationally defined “down” vector) may be referred to as Magnetic North. In various embodiments, Magnetic North, a “down” vector, and/or various other directions, positions, and/or fixed or relative reference frames may define an absolute coordinate frame, for example, where directional measurements referenced to an absolute coordinate frame may be referred to as absolute directional measurements (e.g., an “absolute” orientation).

In some embodiments, directional measurements may initially be referenced to a coordinate frame of a particular sensor (e.g., a sonar transducer assembly or module of sonar system 110) and be transformed (e.g., using parameters for one or more coordinate frame transformations) to be referenced to an absolute coordinate frame and/or a coordinate frame of watercraft 101. In various embodiments, an absolute coordinate frame may be defined and/or correspond to a coordinate frame with one or more undefined axes, such as a horizontal plane local to watercraft 101 referenced to a local gravitational vector but with an unreferenced and/or undefined yaw reference (e.g., no reference to Magnetic North).

Sonar system 110 may be implemented with one or more electrically and/or mechanically coupled controllers, transmitters, receivers, transceivers, signal processing logic devices, autonomous power systems, various electrical components, transducer elements of various shapes and sizes, multichannel transducers/transducer modules, transducer assemblies, assembly brackets, transom brackets, and/or various actuators adapted to adjust orientations of any of the components of sonar system 110, as described herein. Sonar system 110 may be configured to emit one, multiple, or a series of acoustic beams, receive corresponding acoustic returns, and convert the acoustic returns into sonar data and/or imagery, such as bathymetric data, water depth, water temperature, water column/volume debris, bottom profile, and/or other types of sonar data. Sonar system 110 may be configured to provide such data and/or imagery to user interface 120 for display to a user, for example, or to controller 130 for additional processing, as described herein.

For example, in various embodiments, sonar system 110 may be implemented and/or operated according to any one or combination of the systems and methods described in U.S. Provisional Patent Application 62/005,838 filed May 30, 2014 and entitled “MULTICHANNEL SONAR SYSTEMS AND METHODS,” U.S. Provisional Patent Application 61/943,170 filed Feb. 21, 2014 and entitled “MODULAR SONAR TRANSDUCER ASSEMBLY SYSTEMS AND METHODS,” and/or U.S. Provisional Patent Application 62/087,189 filed Dec. 3, 2014 and entitled “AUTONOMOUS SONAR SYSTEMS AND METHODS,” each of which are hereby incorporated by reference in their entirety. In other embodiments, sonar system 110 may be implemented according to other sonar system arrangements that can be used to detect objects within a water column and/or a floor of a body of water.

User interface 120 may be implemented as one or more of a display, a touch screen, a keyboard, a mouse, a joystick, a knob, a steering wheel, a ship's wheel or helm, a yoke, a multifunction display (MFD) and/or any other device capable of accepting user input and/or providing feedback to a user. For example, in some embodiments, user interface 120 may be implemented and/or operated according to any one or combination of the systems and methods described in U.S. Provisional Patent Application 62/069,961 filed Oct. 29, 2014 and entitled “PILOT DISPLAY SYSTEMS AND METHODS,” which is hereby incorporated by reference in its entirety.

In various embodiments, user interface 120 may be adapted to provide user input (e.g., as a type of signal and/or sensor information) to other devices of system 100, such as controller 130. User interface 120 may also be implemented with one or more logic devices that may be adapted to execute instructions, such as software instructions, implementing any of the various processes and/or methods described herein. For example, user interface 120 may be adapted to form communication links, transmit and/or receive communications (e.g., sensor signals, control signals, sensor information, user input, and/or other information), determine various coordinate frames and/or orientations, determine parameters for one or more coordinate frame transformations, and/or perform coordinate frame transformations, for example, or to perform various other processes and/or methods described herein.

In some embodiments, user interface 120 may be adapted to accept user input, for example, to form a communication link, to select a particular wireless networking protocol and/or parameters for a particular wireless networking protocol and/or wireless link (e.g., a password, an encryption key, a MAC address, a device identification number, a device operation profile, parameters for operation of a device, and/or other parameters), to select a method of processing sensor signals to determine sensor information, to adjust a position and/or orientation of an articulated sensor, and/or to otherwise facilitate operation of system 100 and devices within system 100. Once user interface 120 accepts a user input, the user input may be transmitted to other devices of system 100 over one or more communication links.

In one embodiment, user interface 120 may be adapted to receive a sensor or control signal (e.g., from orientation sensor 140 and/or steering sensor/actuator 150) over communication links formed by one or more associated logic devices, for example, and display sensor and/or other information corresponding to the received sensor or control signal to a user. In related embodiments, user interface 120 may be adapted to process sensor and/or control signals to determine sensor and/or other information. For example, a sensor signal may include an orientation, an angular velocity, an acceleration, a speed, and/or a position of watercraft 101 and/or other elements of system 100. In such embodiments, user interface 120 may be adapted to process the sensor signals to determine sensor information indicating an estimated and/or absolute roll, pitch, and/or yaw (attitude and/or rate), and/or a position or series of positions of watercraft 101 and/or other elements of system 100, for example, and display the sensor information as feedback to a user.

In one embodiment, user interface 120 may be adapted to display a time series of various sensor information and/or other parameters as part of or overlaid on a graph or map, which may be referenced to a position and/or orientation of watercraft 101 and/or other element of system 100. For example, user interface 120 may be adapted to display a time series of positions, headings, and/or orientations of watercraft 101 and/or other elements of system 100 overlaid on a geographical map, which may include one or more graphs indicating a corresponding time series of actuator control signals, sensor information, and/or other sensor and/or control signals.

In some embodiments, user interface 120 may be adapted to accept user input including a user-defined target heading, waypoint, route, and/or orientation for an element of system 100, for example, and to generate control signals for navigation control system 190 to cause watercraft 101 to move according to the target heading, waypoint, route, track, and/or orientation. In other embodiments, user interface 120 may be adapted to accept user input modifying a control loop parameter of controller 130, for example, or selecting a responsiveness of controller 130 in controlling a direction (e.g., through application of a particular steering angle) of watercraft 101.

In further embodiments, user interface 120 may be adapted to accept user input including a user-defined target attitude, orientation, and/or position for an actuated device (e.g., sonar system 110) associated with watercraft 101, for example, and to generate control signals for adjusting an orientation and/or position of the actuated device according to the target attitude, orientation, and/or position. More generally, user interface 120 may be adapted to display sensor information to a user, for example, and/or to transmit sensor information and/or user input to other user interfaces, sensors, or controllers of system 100, for instance, for display and/or further processing.

Controller 130 may be implemented as any appropriate logic device (e.g., processing device, microcontroller, processor, application specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of navigation control system 190, watercraft 101, and/or other elements of system 100, for example. Such software instructions may also implement methods for processing sensor signals, determining sensor information, providing user feedback (e.g., through user interface 120), querying devices for operational parameters, selecting operational parameters for devices, or performing any of the various operations described herein (e.g., operations performed by logic devices of various devices of system 100).

In addition, a machine readable medium may be provided for storing non-transitory instructions for loading into and execution by controller 130. In these and other embodiments, controller 130 may be implemented with other components where appropriate, such as volatile memory, non-volatile memory, one or more interfaces, and/or various analog and/or digital components for interfacing with devices of system 100. For example, controller 130 may be adapted to store sensor signals, sensor information, parameters for coordinate frame transformations, calibration parameters, sets of calibration points, and/or other operational parameters, over time, for example, and provide such stored data to a user using user interface 120. In some embodiments, controller 130 may be integrated with one or more user interfaces (e.g., user interface 120) and/or may share a communication module or modules.

As noted herein, controller 130 may be adapted to execute one or more control loops to model or provide device control, steering control (e.g., using navigation control system 190) and/or performing other various operations of watercraft 101 and/or system 100. In some embodiments, a control loop may include processing sensor signals and/or sensor information in order to control one or more operations of watercraft 101 and/or system 100.

For example, controller 130 may be adapted to receive a measured heading 107 of watercraft 101 from orientation sensor 140, a measured steering rate (e.g., a measured yaw rate, in some embodiments) from gyroscope/accelerometer 144, a measured speed from speed sensor 142, a measured position or series of absolute and/or relative positions from GNSS 146, a measured steering angle from steering sensor/actuator 150, perimeter sensor data from perimeter ranging system 148, and/or a user input from user interface 120. In some embodiments, a user input may include a target heading 106, for example, an absolute position and/or waypoint (e.g., from which target heading 106 may be derived), and/or one or more other control loop parameters. In further embodiments, controller 130 may be adapted to determine a steering demand or other control signal for navigation control system 190 based on one or more of the received sensor signals, including the user input, and provide the steering demand/control signal to steering sensor/actuator 150 and/or navigation control system 190.

In some embodiments, a control loop may include a nominal vehicle predictor used to produce a feedback signal corresponding to an average or nominal vehicle/watercraft rather than one specific to watercraft 101. Such feedback signal may be used to adjust or correct control signals, as described herein. In some embodiments, a control loop may include one or more vehicle dynamics modules corresponding to actual vehicles, for example, that may be used to implement an adaptive algorithm for training various control loop parameters, such as parameters for a nominal vehicle predictor, without necessitating real-time control of an actual watercraft.

Orientation sensor 140 may be implemented as one or more of a compass, float, accelerometer, and/or other device capable of measuring an orientation of watercraft 101 (e.g., magnitude and direction of roll, pitch, and/or yaw, relative to one or more reference orientations such as gravity and/or Magnetic North) and providing such measurements as sensor signals that may be communicated to various devices of system 100. In some embodiments, orientation sensor 140 may be adapted to provide heading measurements for watercraft 101. In other embodiments, orientation sensor 140 may be adapted to provide a pitch, pitch rate, roll, roll rate, yaw, and/or yaw rate for watercraft 101 (e.g., using a time series of orientation measurements). In such embodiments, controller 130 may be configured to determine a compensated yaw rate based on the provided sensor signals. In various embodiments, a yaw rate and/or compensated yaw rate may be approximately equal to a steering rate of watercraft 101. Orientation sensor 140 may be positioned and/or adapted to make orientation measurements in relation to a particular coordinate frame of watercraft 101, for example.

Speed sensor 142 may be implemented as an electronic pitot tube, metered gear or wheel, water speed sensor, wind speed sensor, a wind velocity sensor (e.g., direction and magnitude) and/or other device capable of measuring or determining a linear speed of watercraft 101 (e.g., in a surrounding medium and/or aligned with a longitudinal axis of watercraft 101) and providing such measurements as sensor signals that may be communicated to various devices of system 100. In some embodiments, speed sensor 142 may be adapted to provide a velocity of a surrounding medium relative to sensor 142 and/or watercraft 101. For example, speed sensor 142 may be configured to provide an absolute or relative wind velocity or water current velocity impacting watercraft 101. In various embodiments, system 100 may include multiple embodiments of speed sensor 142, such as one wind velocity sensor and one water current velocity sensor.

Gyroscope/accelerometer 144 may be implemented as one or more electronic sextants, semiconductor devices, integrated chips, accelerometer sensors, accelerometer sensor systems, or other devices capable of measuring angular velocities/accelerations and/or linear accelerations (e.g., direction and magnitude) of watercraft 101 and providing such measurements as sensor signals that may be communicated to other devices of system 100 (e.g., user interface 120, controller 130). In some embodiments, gyroscope/accelerometer 144 may be adapted to determine pitch, pitch rate, roll, roll rate, yaw, yaw rate, compensated yaw rate, an absolute speed, and/or a linear acceleration rate of watercraft 101. Thus, gyroscope/accelerometer 144 may be adapted to provide a measured heading, a measured steering rate, and/or a measured speed for watercraft 101. In some embodiments, gyroscope/accelerometer 144 may provide pitch rate, roll rate, yaw rate, and/or a linear acceleration of watercraft 101 to controller 130 and controller 130 may be adapted to determine a compensated yaw rate based on the provided sensor signals. Gyroscope/accelerometer 144 may be positioned and/or adapted to make such measurements in relation to a particular coordinate frame of watercraft 101, for example. In various embodiments, gyroscope/accelerometer 144 may be implemented in a common housing and/or module to ensure a common reference frame or a known transformation between reference frames.

GNSS 146 may be implemented as a global positioning satellite receiver and/or other device capable of determining an absolute and/or relative position of watercraft 101 based on wireless signals received from space-born and/or terrestrial sources, for example, and capable of providing such measurements as sensor signals that may be communicated to various devices of system 100. In some embodiments, GNSS 146 may be adapted to determine and/or estimate a velocity, speed, and/or yaw rate of watercraft 101 (e.g., using a time series of position measurements), such as an absolute velocity and/or a yaw component of an angular velocity of watercraft 101. In various embodiments, one or more logic devices of system 100 may be adapted to determine a calculated speed of watercraft 101 and/or a computed yaw component of the angular velocity from such sensor information. GNSS 146 may also be used to estimate a relative wind velocity or a water current velocity, for example, using a time series of position measurements while watercraft is otherwise lacking powered navigation control.

Perimeter ranging system 148 may be adapted to detect navigation hazards within a monitoring perimeter of watercraft 101 (e.g., within a preselected or predetermined range of a perimeter of watercraft 101) and measure ranges to the detected navigation hazards (e.g., the closest approach distance between a perimeter of watercraft 101 and a detected navigation hazard) and/or relative velocities of the detected navigation hazards. In some embodiments, perimeter ranging system 148 may be implemented by one or more ultrasonic sensor arrays distributed along the perimeter of watercraft 101, radar systems, short range radar systems (e.g., including radar arrays configured to detect and/or range objects between a few centimeters and 10s of meters from a perimeter of watercraft 101), visible spectrum and/or infrared/thermal imaging modules or cameras, stereo cameras, LIDAR systems, combinations of these, and/or other perimeter ranging systems configured to provide relatively fast and accurate perimeter sensor data (e.g., so as to accommodate suddenly changing navigation conditions due to external disturbances such as tide and wind loadings on watercraft 101).

Steering sensor/actuator 150 may be adapted to physically adjust a heading of watercraft 101 according to one or more control signals, user inputs, and/or stabilized attitude estimates provided by a logic device of system 100, such as controller 130. Steering sensor/actuator 150 may include one or more actuators and control surfaces (e.g., a rudder or other type of steering mechanism) of watercraft 101, and may be adapted to sense and/or physically adjust the control surfaces to a variety of positive and/or negative steering angles/positions.

For example, FIG. 1C illustrates a diagram of a steering sensor/actuator in accordance with an embodiment of the disclosure. As shown in FIG. 1C, rear portion 101C of watercraft 101 includes steering sensor/actuator 150 configured to sense a steering angle of rudder 152 and/or to physically adjust rudder 152 to a variety of positive and/or negative steering angles, such as a positive steering angle α measured relative to a zero steering angle direction (e.g., designated by a dashed line 154). In various embodiments, steering sensor/actuator 150 may be implemented with a steering actuator angle limit (e.g., the positive limit is designated by an angle β and a dashed line 156 in FIG. 1), and/or a steering actuator rate limit “R”.

As described herein, a steering actuator rate limit may be a limit of how quickly steering sensor/actuator 150 can change a steering angle of a steering mechanism (e.g., rudder 132), and, in some embodiments, such steering actuator rate limit may vary depending on a speed of watercraft 101 along heading 104 (e.g., a speed of a ship relative to surrounding water, or of a plane relative to a surrounding air mass). In further embodiments, a steering actuator rate limit may vary depending on whether steering sensor/actuator 150 is turning with (e.g., an increased steering actuator rate limit) or turning against (e.g., a decreased steering actuator rate limit) a prevailing counteracting force, such as a prevailing current (e.g., a water and/or air current). A prevailing current may be determined from sensor signals provided by orientation sensor 140, gyroscope/accelerometer 142, speed sensor 144, and/or GNSS 146, for example.

In various embodiments, steering sensor/actuator 150 may be implemented as a number of separate sensors and/or actuators, for example, to sense and/or control a one or more steering mechanisms substantially simultaneously, such as one or more rudders, elevators, and/or automobile steering mechanisms, for example. In some embodiments, steering sensor/actuator 150 may include one or more sensors and/or actuators adapted to sense and/or adjust a propulsion force (e.g., a propeller speed and/or an engine rpm) of watercraft 101, for example, to effect a particular maneuver (e.g., to meet a particular steering demand within a particular period of time), for instance, or to provide a safety measure (e.g., an engine cut-off and/or reduction in watercraft speed).

In some embodiments, rudder 152 (e.g., a steering mechanism) may be implemented as one or more control surfaces and/or conventional rudders, one or more directional propellers and/or vector thrusters (e.g., directional water jets), a system of fixed propellers and/or thrusters that can be powered at different levels and/or reversed to effect a steering rate of watercraft 101, and/or other types or combination of types of steering mechanisms appropriate for watercraft 101. In embodiments where rudder 152 is implemented, at least in part, as a system of fixed propellers and/or thrusters, steering angle α may represent an effective and/or expected steering angle based on, for example, characteristics of watercraft 101, the system of fixed propellers and/or thrusters (e.g., their position on watercraft 101), and/or control signals provided to steering sensor/actuator 150. An effective and/or expected steering angle α may be determined by controller 130 according to a pre-determined algorithm, for example, or through use of an adaptive algorithm for training various control loop parameters characterizing the relationship of steering angle α to, for instance, power levels provided to the system of fixed propellers and/or thrusters and/or control signals provided by controller 130, as described herein.

Propulsion system 170 may be implemented as a propeller, turbine, or other thrust-based propulsion system, a mechanical wheeled and/or tracked propulsion system, a sail-based propulsion system, and/or other types of propulsion systems that can be used to provide motive force to watercraft 101. In some embodiments, propulsion system 170 may be non-articulated, for example, such that the direction of motive force and/or thrust generated by propulsion system 170 is fixed relative to a coordinate frame of watercraft 101. Non-limiting examples of non-articulated propulsion systems include, for example, an inboard motor for a watercraft with a fixed thrust vector, for example, or a fixed aircraft propeller or turbine. In other embodiments, propulsion system 170 may be articulated, for example, and/or may be coupled to and/or integrated with steering sensor/actuator 150, such that the direction of generated motive force and/or thrust is variable relative to a coordinate frame of watercraft 101. Non-limiting examples of articulated propulsion systems include, for example, an outboard motor for a watercraft, an inboard motor for a watercraft with a variable thrust vector/port (e.g., used to steer the watercraft), a sail, or an aircraft propeller or turbine with a variable thrust vector, for example. As such, in some embodiments, propulsion system 170 may be integrated with steering sensor/actuator 150.

Optional thrust maneuver system 172 may be adapted to physically adjust a position, orientation, and/or linear and/or angular velocity of watercraft 101 according to one or more control signals and/or user inputs provided by a logic device of system 100, such as controller 130. Thrust maneuver system 172 may be implemented as one or more directional propellers and/or vector thrusters (e.g., directional water jets), and/or a system of fixed propellers and/or thrusters coupled to watercraft 101 that can be powered at different levels and/or reversed to maneuver watercraft 101 according to a desired linear and/or angular velocity.

Other modules 180 may include other and/or additional sensors, actuators, communications modules/nodes, and/or user interface devices used to provide additional environmental information of watercraft 101, for example. In some embodiments, other modules 180 may include a humidity sensor, a wind and/or water temperature sensor, a barometer, a radar system, a visible spectrum camera, an infrared camera, and/or other environmental sensors providing measurements and/or other sensor signals that can be displayed to a user and/or used by other devices of system 100 (e.g., controller 130) to provide operational control of watercraft 101 and/or system 100 that compensates for environmental conditions, such as wind speed and/or direction, swell speed, amplitude, and/or direction, and/or an object in a path of watercraft 101, for example. In some embodiments, other modules 180 may include one or more actuated and/or articulated devices (e.g., spotlights, visible and/or IR cameras, radars, sonars, and/or other actuated devices) coupled to watercraft 101, where each actuated device includes one or more actuators adapted to adjust an orientation of the device, relative to watercraft 101, in response to one or more control signals (e.g., provided by controller 130).

In general, each of the elements of system 100 may be implemented with any appropriate logic device (e.g., processing device, microcontroller, processor, application specific integrated circuit (ASIC), field programmable gate array (FPGA), memory storage device, memory reader, or other device or combinations of devices) that may be adapted to execute, store, and/or receive appropriate instructions, such as software instructions implementing any of the methods described herein, for example, including for transmitting and/or receiving communications, such as sensor signals, sensor information, and/or control signals, between one or more devices of system 100. In various embodiments, such method may include instructions for forming one or more communication links between various devices of system 100.

In addition, one or more machine readable mediums may be provided for storing non-transitory instructions for loading into and execution by any logic device implemented with one or more of the devices of system 100. In these and other embodiments, the logic devices may be implemented with other components where appropriate, such as volatile memory, non-volatile memory, and/or one or more interfaces (e.g., inter-integrated circuit (I2C) interfaces, mobile industry processor interfaces (MIPI), joint test action group (JTAG) interfaces (e.g., IEEE 1149.1 standard test access port and boundary-scan architecture), and/or other interfaces, such as an interface for one or more antennas, or an interface for a particular type of sensor).

Each of the elements of system 100 may be implemented with one or more amplifiers, modulators, phase adjusters, beamforming components, digital to analog converters (DACs), analog to digital converters (ADCs), various interfaces, antennas, transducers, and/or other analog and/or digital components enabling each of the devices of system 100 to transmit and/or receive signals, for example, in order to facilitate wired and/or wireless communications between one or more devices of system 100. Such components may be integrated with a corresponding element of system 100, for example. In some embodiments, the same or similar components may be used to perform one or more sensor measurements, as described herein.

Sensor signals, control signals, and other signals may be communicated among elements of system 100 using a variety of wired and/or wireless communication techniques, including voltage signaling, Ethernet, WiFi, Bluetooth, Zigbee, Xbee, Micronet, or other medium and/or short range wired and/or wireless networking protocols and/or implementations, for example. In such embodiments, each element of system 100 may include one or more modules supporting wired, wireless, and/or a combination of wired and wireless communication techniques.

In some embodiments, various elements or portions of elements of system 100 may be integrated with each other, for example, or may be integrated onto a single printed circuit board (PCB) to reduce system complexity, manufacturing costs, power requirements, coordinate frame errors, and/or timing errors between the various sensor measurements. For example, gyroscope/accelerometer 144 and controller 130 may be configured to share one or more components, such as a memory, a logic device, a communications module, and/or other components, and such sharing may act to reduce and/or substantially eliminate such timing errors while reducing overall system complexity and/or cost.

Each element of system 100 may include one or more batteries, capacitors, or other electrical power storage devices, for example, and may include one or more solar cell modules or other electrical power generating devices (e.g., a wind or water-powered turbine, or a generator producing electrical power from motion of one or more elements of system 100). In some embodiments, one or more of the devices may be powered by a power source for watercraft 101, using one or more power leads. Such power leads may also be used to support one or more communication techniques between elements of system 100.

In various embodiments, a logic device of system 100 (e.g., of orientation sensor 140 and/or other elements of system 100) may be adapted to determine parameters (e.g., using signals from various devices of system 100) for transforming a coordinate frame of other elements of system 100 to/from a coordinate frame of watercraft 101, at-rest and/or in-motion, and/or other coordinate frames, as described herein. One or more logic devices of system 100 may be adapted to use such parameters to transform a coordinate frame of the other elements of system 100 to/from a coordinate frame of orientation sensor 140 and/or watercraft 101, for example. Furthermore, such parameters may be used to determine and/or calculate one or more adjustments to an orientation of an element of system 100 that would be necessary to physically align a coordinate frame of the element with a coordinate frame of orientation sensor 140 and/or watercraft 101, for example, or an absolute coordinate frame and/or other desired positions and/or orientations. Adjustments determined from such parameters may be used to selectively power adjustment servos/actuators (e.g., of various elements of system 100), for example, or may be communicated to a user through user interface 120, as described herein.

FIG. 1B illustrates a diagram of system 100B in accordance with an embodiment of the disclosure. System 100B may include integrated user interface/controller 120/130, secondary user interface 120, perimeter ranging system 148a and 148b, steering sensor/actuator 150, sensor cluster 160 (e.g., orientation sensor 140, gyroscope/accelerometer 144, and/or GNSS 146), and various other sensors and/or actuators. In the embodiment illustrated by FIG. 1B, watercraft 101 is implemented as a motorized boat including a hull 105b, a deck 106b, a transom 107b, a mast/sensor mount 108b, a rudder 152, an inboard motor 170, articulated thrust maneuver jet 172, an actuated sonar system 110 coupled to transom 107b, perimeter ranging system 148a (e.g., a camera system, radar system, and/or LIDAR system) coupled to mast/sensor mount 108b, optionally through roll, pitch, and/or yaw actuator 162, and perimeter ranging system 148b (e.g., an ultrasonic sensor array and/or short range radar system) coupled to hull 105b or deck 106b substantially above a water line of watercraft 101. In other embodiments, hull 105b, deck 106b, mast/sensor mount 108b, rudder 152, inboard motor 170, and various actuated devices may be provided in a passenger or cargo watercraft, e.g. a marine watercraft.

As depicted in FIG. 1B, watercraft 101 includes actuated sonar system 110, which in turn includes transducer assembly 112 coupled to transom 107b of watercraft 101 through assembly bracket/actuator 116 and transom bracket/electrical conduit 114. In some embodiments, assembly bracket/actuator 116 may be implemented as a roll, pitch, and/or yaw actuator, for example, and may be adapted to adjust an orientation of transducer assembly 112 according to control signals and/or an orientation (e.g., roll, pitch, and/or yaw) or position of watercraft 101 provided by user interface/controller 120/130. Similarly, actuator 162 may be adapted to adjust an orientation of perimeter ranging system 148a according to control signals and/or an orientation or position of watercraft 101 provided by user interface/controller 120/130. For example, user interface/controller 120/130 may be adapted to receive an orientation of transducer assembly 112 and/or perimeter ranging system 148a (e.g., from sensors embedded within the assembly or device), and to adjust an orientation of either to maintain sensing/illuminating a position and/or absolute direction in response to motion of watercraft 101, using one or more orientations and/or positions of watercraft 101 and/or other sensor information derived by executing various methods described herein.

In related embodiments, perimeter ranging system 148b may be implemented as a short range radar system including one or more fixed radar antenna array assemblies (e.g., assembly 148b in FIG. 1B) each configured to generate steerable radar beams and mounted along hull 105b, deck 106b, transom 107b, and/or an interface between those, generally above the at-rest waterline associated with watercraft 101, such as along a gunwale of watercraft 101. Each antenna array assembly 148b may be configured to generate a relatively narrow radar beam, such as in the vertical direction (e.g., parallel to vertical axis 104) that may be steered to a desired relative roll or pitch (e.g., relative to an orientation of watercraft 101) that substantially compensates for roll and/or pitch motion of watercraft 101 about longitudinal axis 102 and/or lateral axis 103, respectively. In general, a monitoring perimeter associated such embodiments of perimeter ranging system 148b may be selected by a timing constraint, for example, or may be limited by a sensitivity and/or power output of perimeter ranging system 148b.

For example, design of a short-range radar system typically involves an engineering trade off in beam width, favoring narrow beams for higher density and detail, and wider beams in order to sense more area at once. In an environment without a fixed orientation, such as on a mobile structure, a wider beam width is often used to guarantee that an expected target may be in view while experiencing an expected amount of roll and pitch. Embodiments of perimeter ranging system 148b implemented as a short range radar system may control one or more antenna array assemblies 148b to generate relatively narrow and high resolution radar beams that may be focused on a particular target and/or according to a desired elevation (e.g., relative and/or absolute). In general, with respect to perimeter ranging system 148b, an absolute elevation may be defined as the vertical angle between the horizon (e.g., at zero degrees) and, for example, a steered beam generated by antenna array assembly 148b, and a relative elevation may be defined as the vertical angle between the plane defined by longitudinal axis 102 and lateral axis 103 of watercraft 101, for example, and such steered beam.

In various embodiments, user interface/controller 120/130 may be configured to receive or determine an absolute roll and/or pitch of watercraft 101 and control perimeter ranging system 148b to generate one or more vertically steered radar beams at desired absolute elevations based, at least in part, on the absolute orientation (e.g., roll and/or pitch) of watercraft 101, an orientation of each antenna array assembly of perimeter ranging system 148b, a relative position of a target or navigation hazard detected by perimeter ranging system 148b, and/or an absolute or relative orientation and/or position of such target. Perimeter ranging system 148b may be configured to derive perimeter sensor data from such generated radar beams and provide the perimeter sensor data to user interface/controller 120/130, as described herein.

Such beam may be relatively narrow in a single dimension (e.g., 1, 5, or 10 degrees in vertical or elevation width, or within the range of 1 to 10 degrees in vertical width) or relatively narrow in overall angular diameter (e.g., 1, 5, or 10 degrees in angular diameter, or within the range of 1 to 10 degrees in angular diameter. More generally, such beam may be steered both vertically and horizontally (e.g., elevation and azimuth). Each antenna array assembly of perimeter ranging system 148b may include a number of different individual radar antenna elements, which may be arranged in a linear or two dimensional spatial array to facilitate a particular desired beam shape, width, diameter, and/or steering range. In particular embodiments, each antenna array assembly may include a 3, 5, or 9 element vertical linear array of radar antenna elements, for example, or multiples of such linear arrays to form two dimensional arrays.

When used to facilitate navigational control for watercraft 101, one or more antenna array assemblies of perimeter ranging system 148b may be used to generate radar beams substantially at a preset or user selected absolute elevation selected to detect approaching hazards, or detect static objects used for position fixing, such as zero degrees absolute elevation. In embodiments where such antenna array assemblies are themselves mounted to hull 105b with a relative elevation of approximately-10 degrees (e.g., directed at an absolute elevation of −10 degrees when vertical axis 104 is aligned with gravity), and watercraft 101 is experiencing roll and/or pitch of +−5 degrees, perimeter ranging system 148b may be configured to generate radar beams steered to compensate for such roll and/or pitch with relative elevations ranging between 5 and 15 degrees, thereby maintaining an absolute elevation of zero degrees. Using such techniques to generate radar beams allows embodiments of perimeter ranging system 148b to reliably detect and provide ranges between a perimeter of watercraft 101 and various navigation hazards, for example, and/or more general navigation, as described herein.

In one embodiment, user interfaces 120 may be mounted to watercraft 101 substantially on deck 106b and/or mast/sensor mount 108b. Such mounts may be fixed, for example, or may include gimbals and other leveling mechanisms/actuators so that a display of user interfaces 120 stays substantially level with respect to a horizon and/or a “down” vector (e.g., to mimic typical user head motion/orientation). In another embodiment, at least one of user interfaces 120 may be located in proximity to watercraft 101 and be mobile throughout a user level (e.g., deck 106b) of watercraft 101. For example, secondary user interface 120 may be implemented with a lanyard and/or other type of strap and/or attachment device and be physically coupled to a user of watercraft 101 so as to be in proximity to watercraft 101. In various embodiments, user interfaces 120 may be implemented with a relatively thin display that is integrated into a PCB of the corresponding user interface in order to reduce size, weight, housing complexity, and/or manufacturing costs.

As shown in FIG. 1B, in some embodiments, speed sensor 142 may be mounted to a portion of watercraft 101, such as to hull 105b, and be adapted to measure a relative water speed. In some embodiments, speed sensor 142 may be adapted to provide a thin profile to reduce and/or avoid water drag. In various embodiments, speed sensor 142 may be mounted to a portion of watercraft 101 that is substantially outside easy operational accessibility. Speed sensor 142 may include one or more batteries and/or other electrical power storage devices, for example, and may include one or more water-powered turbines to generate electrical power. In other embodiments, speed sensor 142 may be powered by a power source for watercraft 101, for example, using one or more power leads penetrating hull 105b. In alternative embodiments, speed sensor 142 may be implemented as a wind velocity sensor, for example, and may be mounted to mast/sensor mount 108b to have relatively clear access to local wind.

In the embodiment illustrated by FIG. 1B, watercraft 101 includes direction/longitudinal axis 102, direction/lateral axis 103, and direction/vertical axis 104 meeting approximately at mast/sensor mount 108b (e.g., near a center of gravity of watercraft 101). In one embodiment, the various axes may define a coordinate frame of watercraft 101 and/or sensor cluster 160. Each sensor adapted to measure a direction (e.g., velocities, accelerations, headings, or other states including a directional component) may be implemented with a mount, actuators, and/or servos that can be used to align a coordinate frame of the sensor with a coordinate frame of any element of system 100B and/or watercraft 101. Each element of system 100B may be located at positions different from those depicted in FIG. 1B. Each device of system 100B may include one or more batteries or other electrical power storage devices, for example, and may include one or more solar cell modules or other electrical power generating devices. In some embodiments, one or more of the devices may be powered by a power source for watercraft 101. As noted herein, each element of system 100B may be implemented with an antenna, a logic device, and/or other analog and/or digital components enabling that element to provide, receive, and process sensor signals and interface or communicate with one or more devices of system 100B. Further, a logic device of that element may be adapted to perform any of the methods described herein.

ECS 192 may be an Electronic Chart Information Display System (ECDIS), or any other suitable ECS. For example, ECS 192 may be a Multifunction Display system (MFD), possibly integrated with user interface 120. Below, ECS 192 and UI 120 are referred to as different entities, but in some embodiments UI 120 is part of ECS 192.

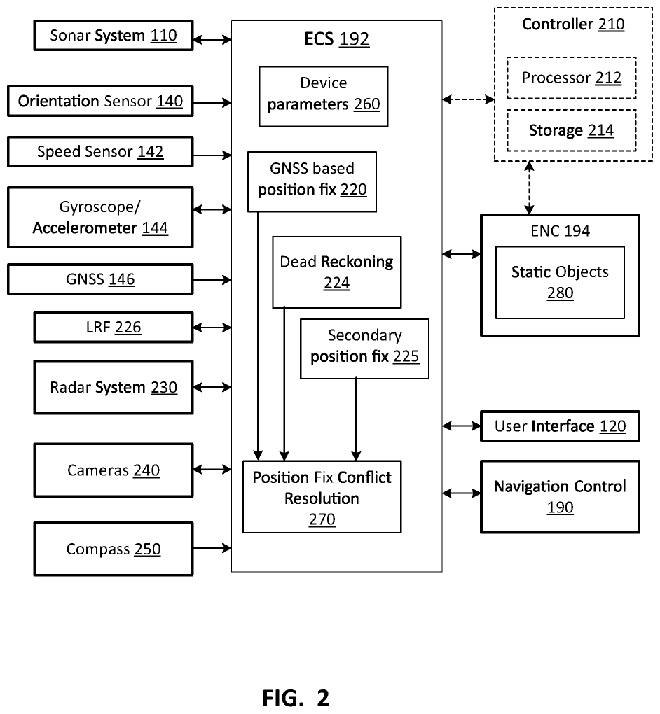

FIG. 2 is a block diagram of a system including ECS 192 according to some embodiments of the present disclosure. ECS 192 may be implemented by a logic device, e.g. a controller 210. Controller 210 may be of any type described above for controller 130. In some embodiments, controllers 210 and 130 are the same controller. In the example of FIG. 2, controller 210 includes a computer processor 212 executing software instructions stored in computer storage 214. Storage 214 may be of any type described above for the computer readable medium of controller 130. ENC 194 may be stored in storage 214 or some other storage on watercraft 101 or remotely from watercraft 101.

ECS 192 receives inputs from GNSS receiver 146 to obtain GNSS position fixes as shown by block 220.

ECS 192 also performs dead reckoning (block 224) based on the vessel speed measured by speed sensor 142, and/or on headings and/or orientations measured by orientation sensor 140, and/or velocities and/or accelerations measured by gyroscope/accelerometer 144.

ECS 192 performs secondary position fixing (block 225) based on laser range finder (LRF, e.g. Lidar) 226 and/or radar system 230 and/or camera(s) 240 and/or compass(es) 250 and/or other devices. Of note, LRF 226, radar 230, and/or cameras 240 may or may not be part of perimeter ranging system 148. Cameras 240 may include cameras of different spectra, e.g. visible light and/or infrared cameras.

Compass(es) 250 may or may not be part of orientation sensor 140. Compass(es) 250 may include a magnetic compass, a gyro compass, a satellite compass, and/or other types known or to be invented. Compass(es) 250 may include a repeater compass.

Before obtaining a secondary position fix, ECS 192 obtains and stores device parameters 260 describing the devices that can be used for a secondary position fix. Such devices may include ranging devices that can measure ranges to static objects. Examples of such devices are LRF 226, radar 230, cameras 240, etc. For example, block 260 may specify the maximum ranges of such devices, the position of such devices on the ship 101, and control information allowing ECS 192 to control such devices.

Any of position fixing blocks 220, 224, 225 may output a position or range of positions, and the outputs may or may not agree with each other. Position conflict resolution block 270 resolves the conflicts between different position outputs. For example, block 270 may output the final position as an average of the position fixes provides by blocks 220, 224, 225, or may output an area (a range of positions) in which the ship is believed to be located. Position information provided by blocks 220, 224, 225, and/or 270 may be displayed on user interface 120 for viewing by the navigator. The outputs of position conflict resolution 270 and/or blocks 220, 224, 225 may be provided to navigation control 190 for automatic navigation and/or alarm generation to avoid navigation hazards detected based on electronic charts ENC 194.

Before obtaining a secondary position fix (block 225), ECS 192 may obtain a predicted fix. The predicted fix can be a GNSS fix obtained by block 220, or a dead reckoning fix obtained by block 224, or a manual fix obtained by the navigator and entered into ECS 192, or a fix obtained from a combination of the GNSS, dead reconning, and/or manual fixes as can be provided by block 270. Upon obtaining the predicted fix, ECS 192 may obtain, from ENC 194, navigation charts covering an area surrounding the predicted fix. From such charts, ECS 192 may obtain information on static objects 280 in the area, and may select some or all of the static objects for use in secondary position fixing at block 225 as described below.

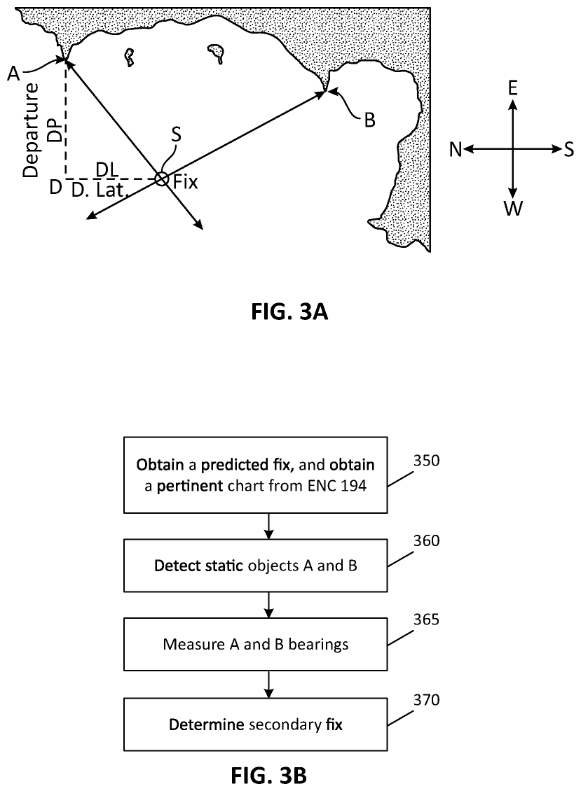

FIGS. 3A, 3B illustrate obtaining a two-point fix by block 225. The two-point fix can be used as a secondary position fix according to some embodiments of the present disclosure. FIG. 3A is an exemplary chart including the position S of own ship (watercraft) 101. FIG. 3B is a flowchart of operations performed by ECS 192. At block 350 in FIG. 3B, ECS 192 obtains a predicted fix, and obtains a pertinent electronic chart from ENC 194, such as the chart shown in FIG. 3A. The electronic chart provided by ENC 194 includes information on static objects in the chart.

At block 360, ECS 192 searches the electronic chart and detects two static objects A, B (headlands in the example of FIG. 3A) viewable from the predicted fix location and having different bearings from the predicted fix location.

At block 365, ECS 192 measures the bearings of objects A and B from the ship (actual location), e.g. by using a compass 250.

At block 370, ECS 192 calculates the secondary fix. Specifically, the exact positions (longitude and latitude) of objects A and B are known from ENC 194. Based on these positions ECS 192 may calculate the length and bearing of line AB, and use triangulation to determine the difference-in-latitudes DL and the departure DP of line AS where S is the actual ship position. From DL, DP, and the position of A, the latitude and longitude of the ship's actual position S can be calculated by ECS 192.

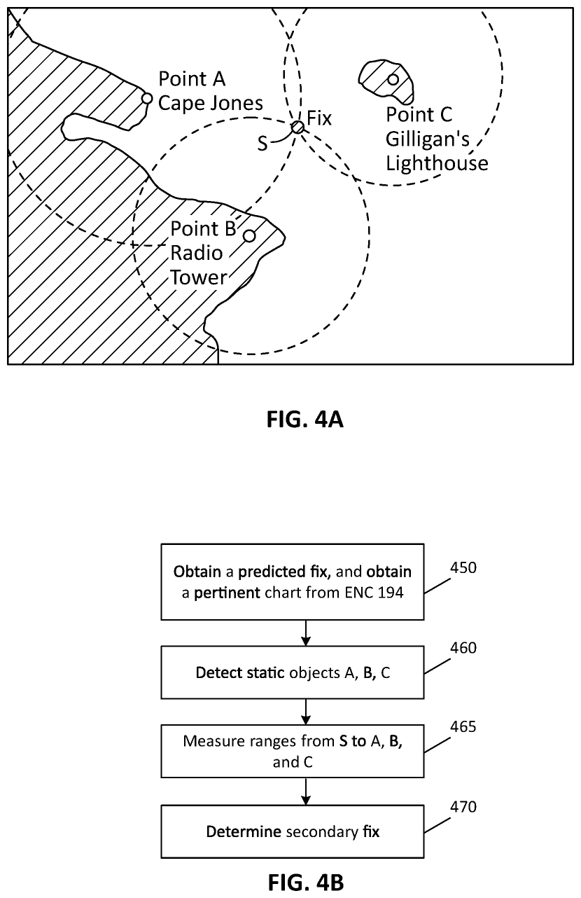

FIGS. 4A, 4B illustrate obtaining a three-point fix by block 225. The three-point fix can be used as a secondary position fix according to some embodiments of the present disclosure. FIG. 4A is an exemplary chart including the position S of own ship (watercraft) 101. FIG. 4B is a flowchart of operations performed by ECS 192.

In block 450 in FIG. 4B, ECS 192 obtains a predicted fix and obtains a pertinent chart from ENC 194 using the same process as in block 350.

At block 460, ECS 192 searches the electronic chart and detects three static objects A, B, C viewable from the predicted fix location and having different bearings from the predicted fix location.

At block 465, ECS 192 measures the ranges from ship S (actual position) to objects A, B, C. The ranges may be determined using LRF 226 and/or radar 230 and/or sonar 110 and/or cameras 240 for example.

At block 470, ECS 192 calculates the secondary fix. Specifically, since the exact positions (longitude and latitude) of objects A, B, C are known from ENC 194, the ship position S can be obtained using geometry, e.g. by triangulation or by plotting the circles centered at the points A, B, and C, each circle having a radius equal to the corresponding range. Once the circles are plotted, their intersection point can be determined as the secondary position fix.

Other techniques for two- or three-point position fixing may also be used.

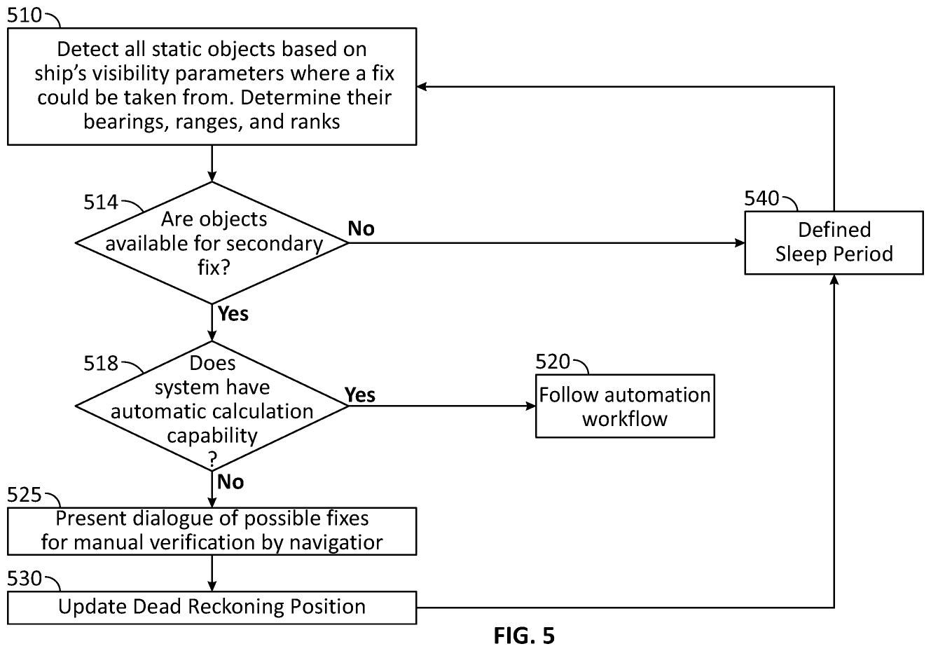

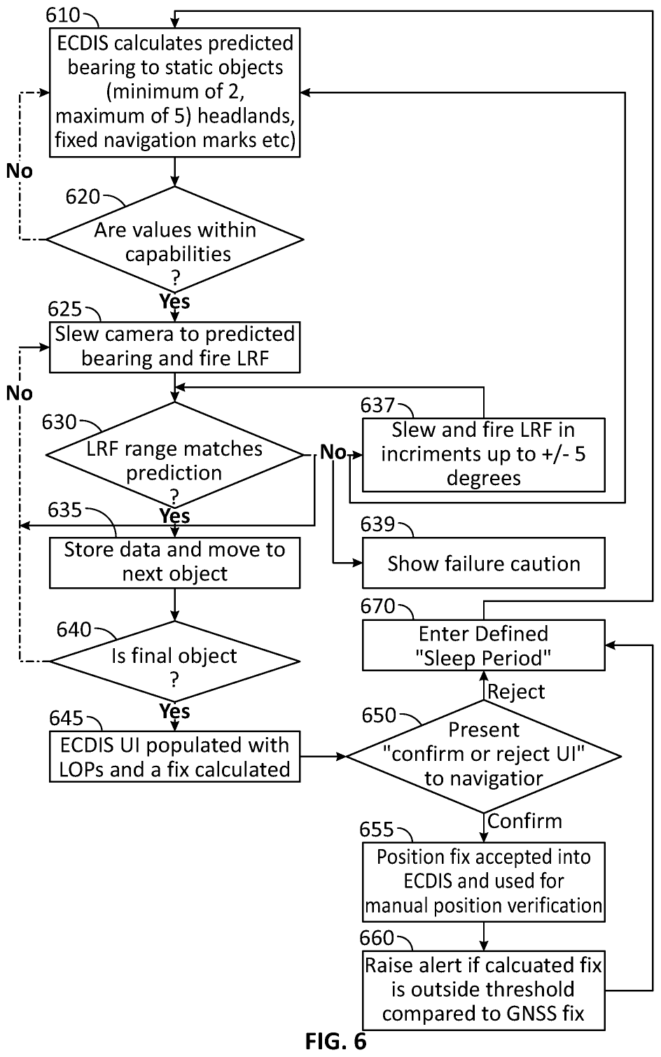

FIG. 5 is a flowchart showing additional aspects of secondary position fixing according to some embodiments of the present disclosure. Various aspects of the process of FIG. 5 can be present in the processes of FIG. 3B or 4B, and vice versa-aspects of the processes of FIG. 3B or 4B can be used in the process of FIG. 5. ECS 192 will be referred to as ECDIS, but the invention is not limited to ECDIS and includes any suitable ECS.

The process of FIG. 5 may be a continuously executed loop. Block 510 is similar to blocks 350 and 360, or blocks 450 and 460: ECDIS 192 obtains a predicted fix and a pertinent electronic chart, and searches the chart to detect static objects viewable from the watercraft assuming the watercraft is at the predicted fix location. As used herein, the term “viewable” means that the objects may be viewed by the navigator (human being) and/or one or more devices in block 260 (e.g. LRF 226 or radar 230 or sonar 110). The static objects are detected taking into account the ship's visibility horizon determined assuming the ship is at the predicted fix location. A chart engine within ECDIS 192 can calculate the visibility horizon based on how high the ship 101 is (e.g. depending on the ship's displacement), and/or how high the devices 260 are positioned on the ship, and/or based on the maximum ranges of devices 260 as recorded in block 260 (we use the same numeral 260 for the block 260 and the devices themselves) Suitable objects detected by ECDIS 192 on the electronic chart may include headlands, jetties coming off the land, landmarks such as radio towers, and others.

ECDIS 192 may populate the detected static objects into a database (implemented by controller 210 or otherwise). ECDIS 192 may use the electronic chart to calculate the predicted ranges and bearings for the detected static objects. The ranges and bearings are calculated from the predicted fix location. ECDIS 192 may rank the detected static objects by their suitability for a secondary fix and select up to five, or some other number, top ranking objects. The objects are ranked based on how likely they are to be actually seen by the navigator or by pertinent devices 260 so that a bearing or range could be taken from these objects. The object ranking may depend on the object type. For example, headlands, radio towers, and any towers having a light at the top may be given the highest rankings; while peers and fixed navigation marks may have lower rankings. The object ranking may be based on the ship's preferences, which may be provided to ECDIS 192 via user interface 120 or in some other way.

The object rankings may also be affected by the predicted ranges that may be calculated by ECDIS 192 based on the electronic chart: the objects closer to the ship may get a higher rank. In some embodiments, up to a maximum number of top ranking objects are selected as noted above, and their predicted bearings and ranges are stored in the database by ECDIS 192.

ECDIS 192 determines at block 514 whether a secondary fix can be obtained based on the objects selected at block 510. For example, ECDIS 192 may determine whether the selected objects include at least two objects with different bearings relative to the ship assuming the ship is at the predicted location (predicted fix location). If a secondary fix can be obtained, ECDIS 192 checks at block 518 whether the system 100 has automatic calculation capability to obtain the secondary fix. Automatic calculation capability may imply that ECDIS 192 can control pertinent devices 260 to measure ranges or bearings as needed.

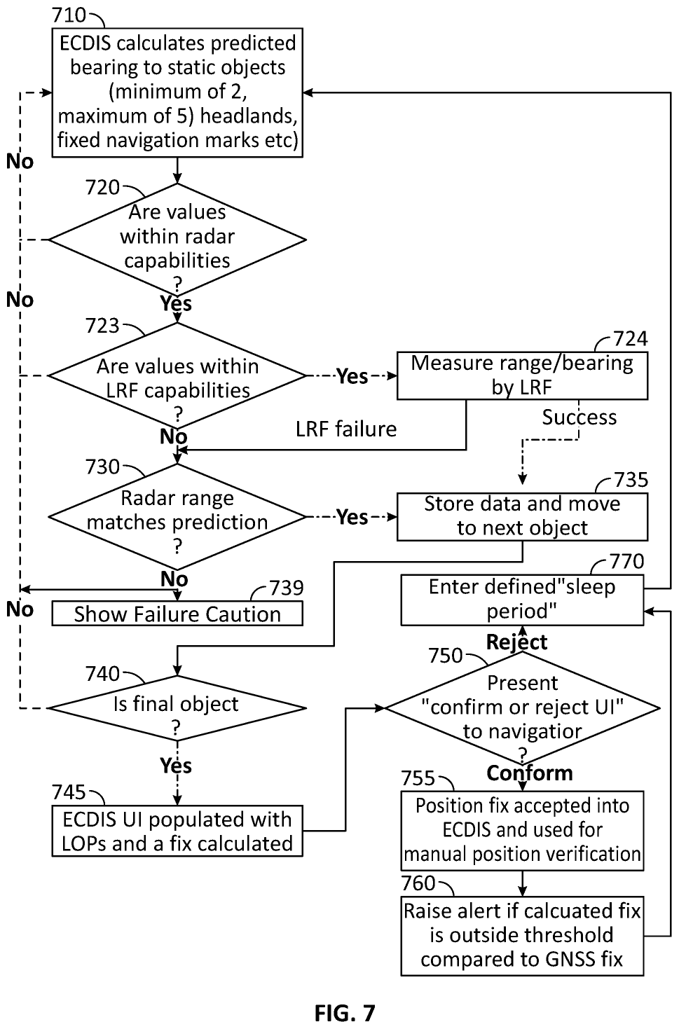

If the answer is positive at block 518, ECDIS 192 controls pertinent devices 260 to automatically measure appropriate ranges and/or bearings, and ECDIS 192 uses such ranges and/or bearings to calculate a secondary fix, as shown at block 520 and described elsewhere herein (see FIGS. 6 and 7 for example).

In some embodiments, after receiving a positive answer at block 518 but before proceeding to block 520, ECDIS 192 requests the navigator via UI 120 whether or not to obtain a secondary fix automatically, and ECDIS 192 may also inform the navigator how long ago the last secondary fix was obtained. ECDIS 192 then proceeds to block 520 only if the navigator responds by requesting an automatic secondary fix. In some embodiments, ECDIS 192 has a setting that the navigator may set to cause ECDIS 192 to always ask the navigator whether or not to obtain a secondary fix automatically, or to never ask the navigator but always proceed to automatic-fix block 520.

If the answer is negative at block 518, or if the navigator indicates via UI 120 or via a setting in ECDIS 192 that the automatic position fixing should not be attempted, ECDIS 192 proceeds to block 525 to present to the navigator, on user interface 120, a list of the objects selected at block 510 based on the electronic chart, and to present secondary fix options available. A secondary fix option may include a set (possibly a subset) of the selected objects, and an indication as to what kind of fix can be obtained based on the set of objects, e.g. two-point or three-point or some other kind of fix. For each option ECDIS 192 also indicates to the navigator, on UI 120, what kind of data will be needed for each object, e.g. the bearing for the two-point fix, or the range for the three-point fix, or other data.

In response, the navigator may select a secondary fix option, and may manually obtain the bearings and/or ranges as indicated by ECDIS 192, e.g. by using devices 260 and/or other devices, such as a pair of monoculars to obtain bearings. Upon determining the bearings and/or ranges, the navigator enters them into ECDIS 192 (via user interface 120 for example). ECDIS 192 will then calculate the secondary fix based on such ranges and/or bearings.

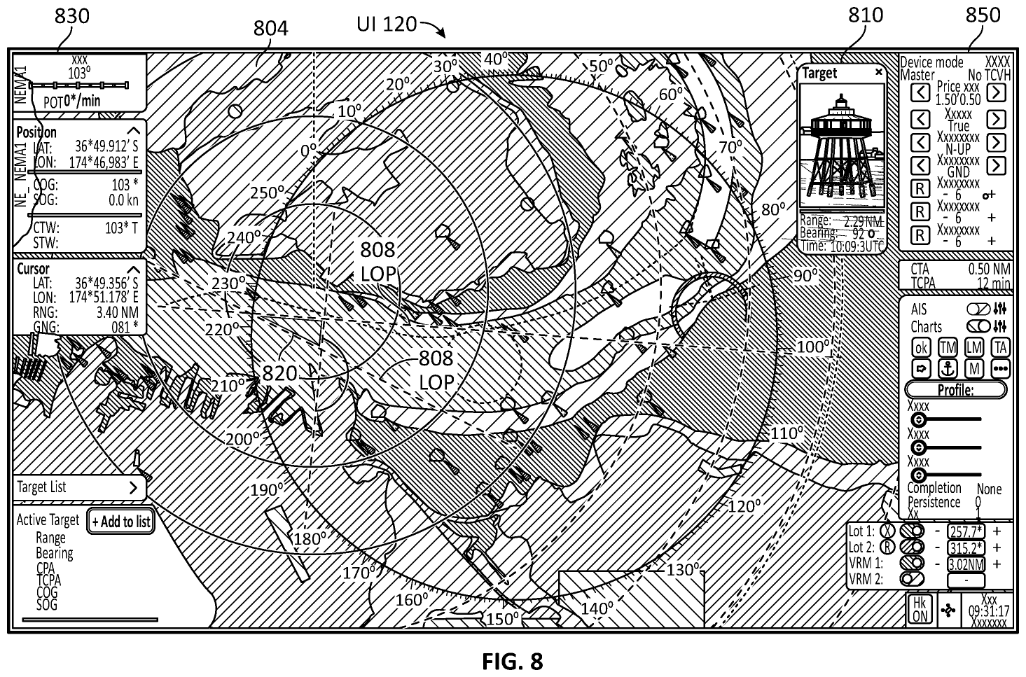

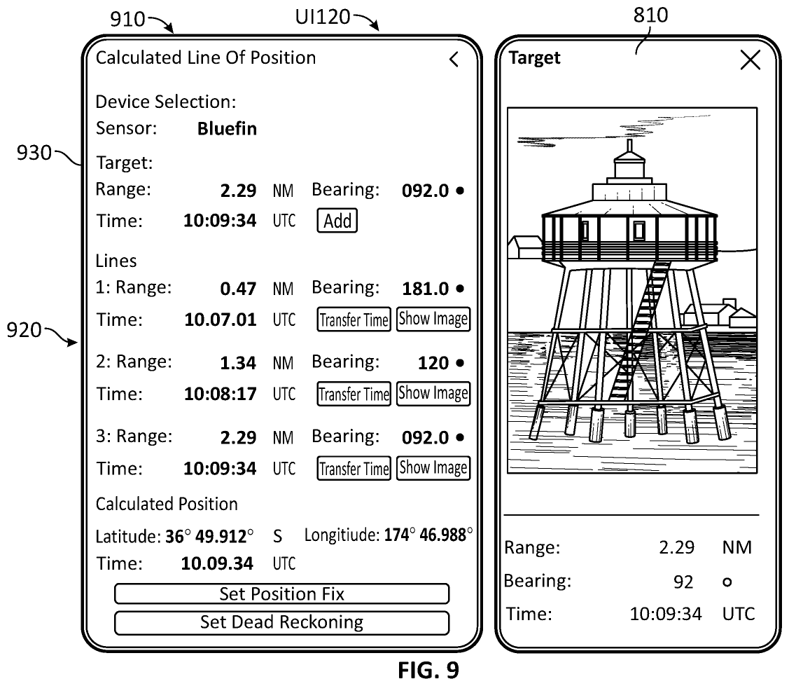

ECDIS 192 may output the secondary fix on UI 120 as the ship's longitude/latitude, and/or as a mark on the electronic chart displayed on UI 120, and/or in some other format; see FIGS. 8 and 9 for example. ECDIS 192 may also combine the secondary fix with the predicted fix (see block 270 in FIG. 2) and output the combined fix in any of the formats described above.

ECDIS 192 also updates the dead reckoning position with the secondary fix or the combined fix.

The loop is then repeated after a delay shown as sleep period at block 540. The sleep period may depend on the ship position as determined by the predicted fix and/or the secondary fix and/or the combined fix. For example, in open seas, the sleep period may be longer (e.g. 30 minutes) than in coastal waters (e.g. 5 minutes).

IF ECDIS 192 determines at block 514 that a secondary fix is unavailable based on the selected objects, or if the navigator indicates at block 525 that the navigator does not wish to obtain a secondary fix, ECDIS 192 invokes a sleep period at block 540, and then returns to block 510 for a new iteration of the secondary-fix loop.

FIG. 6 is a flowchart of an exemplary implementation of automation flow block 520. At block 610, ECDIS 192 determines the predicted bearings and/or ranges for two or more of the objects selected at block 510 assuming the ship is at the predicted location. For example, ECDIS 192 may read the predicted bearings and/or ranges from the database populated at block 510, and/or may recalculate the predicted bearings and/or ranges based on the ENC 194 chart and predicted fix as described above.

At block 620, ECDIS 192 checks if the predicted bearings and ranges are within the capabilities of the navigation system. In particular, the predicted range values should be within the capabilities of radar 230 and/or LRF 226 and/or cameras 240 and/or other ranging devices in block 260. In some embodiments, this check involves comparing the maximum ranges of the ranging devices with the ship horizon, which may be done at block 620 and/or 510. Likewise, ECDIC 192 may check that the predicted bearings are within the capabilities of the pertinent devices, e.g. orientation sensor 140 and/or cameras 240 and/or compass 250 and/or other devices 260.

If the predicted bearing/range values are not within capabilities of devices 260, ECDIS 192 returns to block 610 to recalculate the predicted fix and the corresponding predicted bearings and ranges to the objects selected at block 510. Then ECDIS 192 loops back to block 620. This loop of blocks 610, 620 is repeated until the predicted bearing/range values fall within capabilities of devices 260. In some embodiments, in at least some of the iterations of blocks 610/620, ECDIS 192 may also select additional objects from the objects detected at block 510.

If the selected objects do not come within the capabilities of the navigation system within a predefined period of time, ECDIC 192 may abandon the process of FIG. 6 and return to block 510 to detect objects anew.

If block 620 determines that the predicted bearings/ranges are within the device 260 capabilities, ECDIS 192 processes each selected object separately starting at block 625, to measure the range and/or bearing for each object as needed. In the example of FIG. 6, the predicted range of the current object is within the capabilities of LRF 226, and ECDIS 192 determines the current object's range and bearing using a camera 240 integrated with LRF 226, but other ranging devices can be used instead or in addition.

In the example shown, ECDIS 192 slews the camera 240 and the LRF 226 to the predicted bearing of the current object, and fires (activates) the LRF 226 to get a range measurement. At block 630, ECDIS 192 compares the measured range to the predicted range. If the two range match, e.g. if they differ by at most an acceptable error, ECDIS 192 accepts the measured range from LRF 226 as the range that will be used for secondary fix calculation. ECDIS 192 uses the measured range as the final range or combines the measured range with the predicted range to obtain the final range, and stores the final range, and the corresponding (predicted) bearing, in storage 214 at block 635. (The acceptable error may depend on the kind of ship and how fast the ship is moving, and can for example be between 5 meters and 200 meters or some other value.)

If the ranges do not match at block 630, ECDIS 192 may adjust the device 260 (camera/LRF) at block 637 and measure the range again. For example, the camera and the LRF 226 may be slewed by a small incremental angle, e.g. +/−5°, and LRF 226 can be activated again to get a range measurement. Then ECDIS 192 returns to block 630 to compare the measured range against the predicted range. This loop of blocks 637, 630 can be performed a number of times to attempt to get a match between the predicted range and the measured range. If a match is obtained, ECDIS 192 proceeds to block 635 to store the measured range and corresponding bearing, or combine the measured range and/or bearing with the predicted range and/or bearing to obtain and store the final range and/or bearing as described above.

If a match is not obtained after a certain number of tries covering a predetermined range of angles (e.g. up to +/−30° from the predicted bearing), ECDIS 192 may return to block 625 to process the next object, or may proceed to failure block 639 if there are no more objects to try or if the current object is indispensable for a secondary fix (e.g. if there is only one other selected object possibly available for a secondary fix). At block 639, ECDIS 192 informs the navigator via UI 120 that a secondary fix could not be automatically obtained for the current object, and warns the navigator to exercise caution.

From block 635, ECDIS 192 proceeds to block 640 to check if the ranges and/or bearings have been determined for all the objects selected at block 510, or at least for enough of the selected objects to obtain a secondary fix. If the answer is negative, i.e. additional selected objects need to be processed, ECDIS 192 returns to block 625 to process the next object.

If no more selected objects need to be processed as determined at block 640, and a secondary fix can be calculated based on the measured ranges and bearings, ECDIS 192 calculates the secondary fix, and populates the display of UI 120 with the final ranges and bearings and the secondary fix for the navigator to view (block 645). The bearings can be displayed as Lines of Position (LOPs). At block 650, ECDIS 192 requests the navigator to confirm or reject the secondary fix.

In some embodiments, the navigator may request ECDIS 192 to display camera images (photographs) of the objects used to obtain the fix. For example, in blocks 625 and 637, when LRF 226 is activated to obtain a range measurement, the integrated camera 240 captures an image of the object seen by the LRF (camera 240 may be a visible-wavelength or infrared camera for example). The image may be shown to the navigator on UI 120 at block 650 to allow the navigator to compare the image on UI 120 with the navigator's observation of actual objects in the scene viewed by the navigator. See for example FIGS. 8 and 9 showing a display on UI 120. The display provides measured ranges and corresponding bearings for a number of objects. If the navigator selects an object, a camera image of the object is displayed at 810. The navigator may match the camera image 810 with the navigator's own observation before confirming or rejecting the secondary fix.

If the navigator confirms the secondary fix, the fix is accepted by ECDIS 192 (block 655) and may be used as a new predicted fix for future secondary fixes and/or may be set as the new initial value for dead reckoning (block 224).

Also (block 660), ECDIS 192 raises an alert on UI 120 if the secondary fix is outside a threshold when compared to the predicted fix (e.g. GNSS fix).

Then ECDIS 192 enters a sleep period (block 670). The sleep period block 670 is also entered from block 650 if the navigator rejects the secondary fix. Then ECDIS 192 may return to block 610 for a new iteration of the loop if the fix has been rejected by the navigator, or may return to block 510 to obtain other static objects for a secondary fix.

The methods described herein may be modified to work fully automatically, i.e. without navigator participation (hence skipping block 650), and may work for unmanned watercraft. Further, the methods may use other devices 260 instead of, or in addition to, the LRF. FIG. 7 illustrates use of radar 230 and LRF 226. The LRF 226 is integrated with a camera 240 as in FIG. 6. The radar may have a higher range, e.g. 20 mi to 30 mi, than a typical LRF (2 km to 12 km), but the LRF may be more accurate. The invention is not limited to particular ranges or accuracy.

Block 710 in FIG. 7 is performed as described above for block 610, to determine predicted ranges and/or bearings of the objects selected for the secondary fix.

Block 720 is performed for radar 230 as described above for block 620, to determine whether the predicted ranges are within the capabilities of radar 230. If not, ECDIS 192 loops back to block 710, because if the predicted ranges exceed the radar capabilities then the predicted ranges would also exceed LRF 226 capabilities. ECDIS 192 recalculates the predicted fix and the corresponding predicted bearings and ranges to the objects selected at block 510. This loop of blocks 710/720 is repeated as described above for blocks 610/620 until the predicted bearing/range values fall within capabilities of radar 230 or until ECDIC 192 abandons the process of FIG. 7 and returns to block 510 to detect objects anew.

If the predicted ranges are within the radar capabilities at block 720, ECDIS 192 processes the selected objects one by one. For each object, ECDIS 192 checks at block 723 whether the object's predicted range is within the maximum range of LRF 226.

If the answer is positive, ECIDS 192 uses LRF 226 and integrated camera 240 to measure the object's range and the corresponding bearing at block 724 using the same process as described above in connection with blocks 625, 630, 637. If the process is successful, ECDIS 192 proceeds to block 735 to store the final range and bearing as described above for block 635.

If however the LRF process fails, ECDIS 192 uses radar 230 to obtain a range measurement at the predicted bearing, and ECDIS 192 checks at block 730 whether the measured range is within an acceptable error from the predicted range. See the description of block 630 above. If the answer is positive, ECDIS 192 accepts the measured range from radar 230 as the range that will be used for secondary fix calculation. ECDIS 192 accepts the measured range as the final range, and/or combines the measured range with the predicted range to obtain the final range, and stores the final range, and the corresponding (predicted) bearing, in storage 214 at block 735.

If the ranges do not match at block 730, ECDIS 192 may return to block 723 to process the next object, or may proceed to failure block 739 if there are no more objects to try or if the current object is indispensable for a secondary fix. Block 739 is similar to block 639: ECDIS 192 informs the navigator via UI 120 that a secondary fix could not be automatically obtained for the current object, and warns the navigator to exercise caution.

From block 735, ECDIS 192 proceeds to block 740 to check if the ranges and/or bearings have been determined for all the selected objects, or alternatively for enough objects to obtain a secondary fix. If additional selected objects are available and desired for a secondary fix, ECDIS 192 returns to block 723 to process the next object.

When all the selected objects have been processed, or enough selected objects have been processed to obtain a secondary fix, as determined at block 740, ECDIS 192 proceeds to block 745. Blocks 745, 750, 755, 760, 770 are identical to corresponding blocks 645, 650, 655, 660, 670.

The invention is not limited to specific processes described above, and includes other processes, devices 260, or electronic charts other than ENC 194. For example, the invention is not limited to laser range finders, radars, or cameras to determine ranges or bearings with respect to static objects. Other devices may be used instead or in addition, including for example sonar 110. Further, the static objects are not limited to above-water objects, but may include static underwater objects from which the ranges or bearings can be taken to obtain a position fix. Of note, electronic charts provided by ENC 194 include underwater objects.

The invention is not limited to the particular operations described above.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the invention. Accordingly, the scope of the invention is defined only by the following claims.

What is claimed is:

1. An apparatus comprising:
an electronic chart system (ECS) configured to be coupled to a user interface;
the ECS being implemented using a logic device configured to:
obtain a predicted fix for a watercraft position;
based on the predicted fix, obtain an electronic chart of an area containing a location of the predicted fix; and
search the electronic chart for static objects whose ranges and/or bearings are viewable from the watercraft at the predicted fix location.

2. The apparatus of claim 1, wherein the logic device is further configured to provide results of the search on the user interface.

3. The apparatus of claim 2, wherein providing the results comprises indicating on the user interface whether or not a three-point position fix is available based on static objects found in the search.

4. The apparatus of claim 3, wherein the logic device is further configured to:
control one or more ranging devices provided on the watercraft to take range measurements to at least two of the static objects, and obtain ranges based on the range measurements; and
calculate a watercraft position fix based on the obtained ranges.

5. The apparatus of claim 4, wherein the logic device is further configured to:
compare the calculated watercraft position fix with the predicted fix, and provide an alert on the user interface if the calculated watercraft position fix is outside a threshold compared to the predicted fix.

6. The apparatus of claim 1, wherein the logic device is further configured to:
control one or more ranging devices provided on the watercraft to take a range measurement to at least one of the static objects, and obtain a range based on the range measurement;
control a camera provided on the watercraft to capture an image of the at least one of the static objects; and
provide, on the user interface:
a range and a bearing that correspond to the range measurement; and
the captured image.

7. The apparatus of claim 6, wherein the one or more ranging devices comprise a laser range finder (LRF).

8. The apparatus of claim 6, wherein the one or more ranging devices comprise a radar and/or a sonar.

9. The apparatus of claim 1, wherein the logic device is configured to:
obtain, based on the electronic chart and the predicted fix, a predicted range and predicted bearing of at least one of static objects found in the search; and
control one or more ranging devices provided on the watercraft to take a range measurement based on the predicted bearing.

10. The apparatus of claim 9, wherein the logic device is further configured to:
if the range measurement is within a threshold compared to the predicted range, use the range measurement to calculate a fix for the watercraft; and
if the range measurement if outside of the threshold compared to the predicted range, then:
calculate a modified bearing based on the predicted bearing; and
control one or more ranging devices provided on the watercraft to take a range measurement based on the modified bearing.

11. A method comprising performing, by a logic device used to implement an electronic chart system (ECS), operations of:
obtaining a predicted fix for a watercraft position;
based on the predicted fix, obtaining an electronic chart of an area containing a location of the predicted fix; and
searching the electronic chart for static objects whose ranges and/or bearings are viewable from the watercraft at the predicted fix location.

12. The method of claim 11, further comprising the logic device providing results of the search on a user interface coupled to the ECS.

13. The method of claim 12, wherein providing the results comprises indicating on the user interface whether or not a three-point position fix is available based on static objects found in the search.

14. The method of claim 13, further comprising the logic device performing operations of:
controlling one or more ranging devices provided on the watercraft to take range measurements to at least two of the static objects, and obtaining ranges based on the range measurements; and
calculating a watercraft position fix based on the obtained ranges.

15. The method of claim 14, further comprising the logic device performing operations of:
comparing the calculated watercraft position fix with the predicted fix, and providing an alert on the user interface if the calculated watercraft position fix is outside a threshold compared to the predicted fix.

16. The method of claim 11, further comprising the logic device performing operations of:
controlling one or more ranging devices provided on the watercraft to take a range measurement to at least one of the static objects, and obtaining a range based on the range measurement;
controlling a camera provided on the watercraft to capture an image of the at least one of the static objects; and
providing, on the user interface:
a range and a bearing that correspond to the range measurement; and
the captured image.

17. The method of claim 16, wherein the one or more ranging devices comprise a laser range finder (LRF).

18. The method of claim 16, wherein the one or more ranging devices comprise a radar and/or a sonar.

19. The method of claim 11, further comprising the logic device performing operations of:
obtaining, based on the electronic chart and the predicted fix, a predicted range and predicted bearing of at least one of static objects found in the search; and
controlling one or more ranging devices provided on the watercraft to take a range measurement based on the predicted bearing.

20. The method of claim 19, further comprising the logic device performing operations of:
if the range measurement is within a threshold compared to the predicted range, using the range measurement to calculate a fix for the watercraft; and
if the range measurement if outside of the threshold compared to the predicted range, then:
calculating a modified bearing based on the predicted bearing; and
controlling one or more ranging devices provided on the watercraft to take a range measurement based on the modified bearing.
